(19) United States
(12) Patent Application Publication
(10) Pub. No.: US 2021/0318706 A1
(43) Pub. Date: Oct. 14, 2021

(54) APPARATUS AND METHOD TO IMPROVE INTEGRATED VOLTAGE REGULATORS

(71) Applicant: Keith Pinson, Swindon (GB)

(72) Inventor: Keith Pinson, Swindon (GB)

(21) Appl. No.: 13/997,202

(22) PCT Filed: Sep. 30, 2011
(86) PCT No.: PCT/US2011/054392

§ 371 Date: Apr. 3, 2015

(51) Int. Cl. G05F 1/63; G05F 1/565

(52) U.S. Cl. CPC G05F 1/63; G05F 1/565

(57) ABSTRACT

A resistor capacitor damping decoupling circuit or network is provided on a circuit of in an integrated circuit system of a chip (SOC) to quickly damp voltage ringing caused by an input voltage. The voltage ringing is the result of a parasitic inductance and capacitance caused by the input voltage.

### BACKGROUND

Systems on a chip or SOC(s) may include multiple discrete devices and circuits on a single integrated circuit die. The devices and circuits may be made of transistors and other discrete components. As SOCs evolve, they become smaller in size and include more devices and circuits. SOCs may incorporate newer 32 nanometer and smaller (i.e., 32 nm) transistor gates, as well legacy 180 nanometer (180 nm) transistor gates.

SOCs typically rely on an external power supply and may include switching voltage regulators to provide proper voltage to the various circuits. Due to the nature of switching voltage regulators pulses of current are drawn from the input power supply or line in. The pulses of current flow through undesired parasitic inductance. The input power supply further contains an inherent capacitance. The capacitance and parasitic inductance may form a resonant circuit that is excited by the pulses of current drawn by the switching regulator, which causes ringing at the natural frequency of the resonant circuit. The ringing in turn may lead to a high peak voltage. The high peak voltage may exceed electrical overstress (EOS) limits of the transistors and degrade the reliability of the circuits.

Typical solutions to address the problem of parasitic inductance may include the use of higher voltage rated transistors; however, this may not be possible for 32 nm technology. The use of more complex circuit designs using stacked lower voltage transistors may be implemented at a greater cost. Such an approach involves costlier designs and uses more die area. Large decoupling capacitors may be used to reduce the magnitude of voltage overstress; however, this uses more die area as well. The use of more die area is of itself costly in the design of SOCs.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a diagram illustrating an example device with systems on a chip (SOCs) implementing a resistor capacitor damping network to damp voltage ringing.

FIG. 2 is a diagram illustrating an example system on a chip (SOC) implementing a resistor capacitor damping network to damp voltage ringing.

FIG. 3 is a diagram illustrating reduction of ringing in an example system on a chip (SOC) implementing a resistor capacitor damping network.

FIG. 4 is a flow chart illustrating an example method for reduction of ringing to improve integrated voltage regulators.

### DETAILED DESCRIPTION

### Overview

A resistor capacitor damping decoupling circuit or network is included in an integrated circuit system of a chip (SOC) to quickly damp voltage ringing caused by an input voltage. Voltage overstress, and particularly the time of voltage overstress, is minimized in order to improve device/component reliability of the SOC.

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Example Device

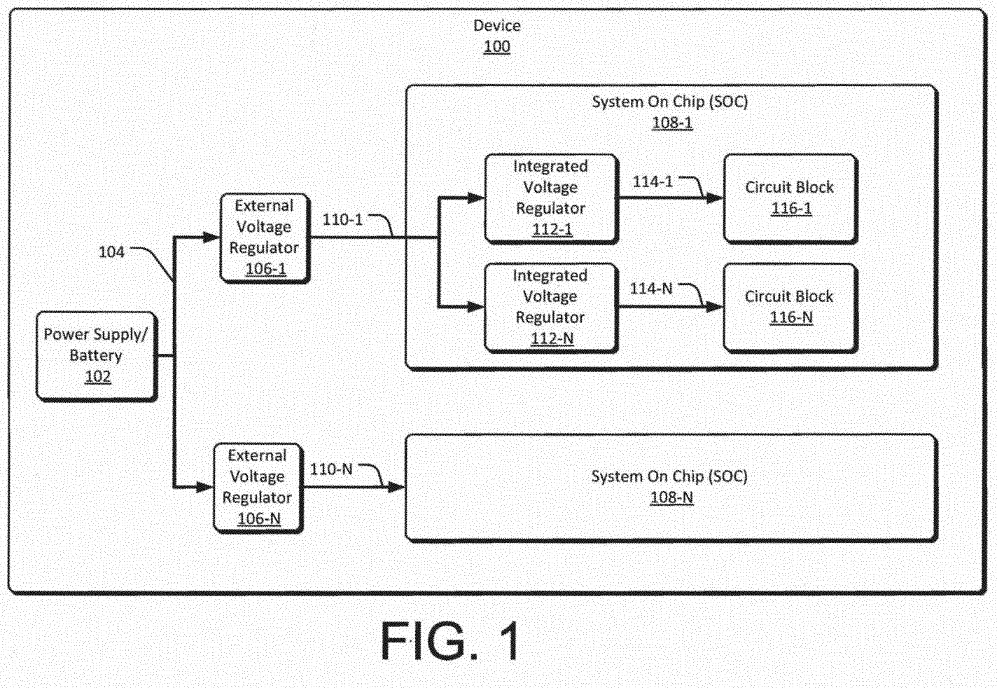

FIG. 1 shows an example device 100 with systems on a chip (SOCs) implementing a resistor capacitor damping network to damp voltage ringing. Device 100 includes various electronic devices, such as smart phones, computing devices, smart televisions, etc. It is to be understood that any device implementing an SOC and integrated circuits may apply to device 100.

Device 100 includes one or more power supplies, as represented by power supply/battery 102. Power supply/battery 102 may provide an initial voltage, for example 12.0 volts (v). In certain implementations, the power supply/battery 102 is external to the device 100. Power supply/battery 102 provides the voltage (e.g., 12.0 v) on line 104.

In certain implementations, the line 104 provides the voltage to one or more external voltage regulators 106. The voltage regulators 106 convert the received voltage to desired voltages for respective SOC's 108. For example, external voltage regular 106-1 provides a 3.3 v input to SOC 108-1, and external voltage regulator 106-N provides a 5.0 v input to SOC 108-N. SOCs 108 may support and provide different voltages for different technology, such as 32 nm transistor gate technology and older legacy technology such as 180 nm transistor gate technology. Furthermore, different voltages may be provided for different interfaces, such as universal serial bus (USB) interfaces. In this example, external voltage regulator 106-1 provides the 3.3. v input on line 110-1 to SOC 108-1, and external voltage regular 106-N provides the 5.0 v input on line 110-N to SOC 108-N.

It is expected that parasitic inductance may occur along input lines 110 from the external voltage regulators 106 to the SOCs 108. Parasitic inductance is typically outside of an integrated circuit (IC) or the SOC 108; however, there can be some parasitic inductance in the IC or SOC 108. Along with inherent capacitance from the input voltage, may produce ringing that leads to electrical overstress in SOCs 108. Therefore, resistor capacitor damping networks are introduced along input lines (e.g., lines 110 and 112) from the external power inputs (e.g., external voltage regulators 106). As discussed below the resistor capacitor damping networks are integrated in the SOCs 108. By integrating the integrated voltage regulators 112 as part of the SOCs 108, additional rails or input/outputs to the SOCs are avoided.

In this example, SOC 108-1 includes one or more integrated voltage regulators 112. In this example, integrated voltage regulator 112-1 provides an input voltage of 1.0 v along a line 114-1, and integrated voltage regulator 112-N provides an input voltage of 1.8 v along a line 114-N. For 32 nm transistor gate technology, input voltage is typically 1.0 v. For older 180 nm transistor gate technology, input voltage is typically 1.8 v. Therefore, in this example, integrated voltage regulator 112-1 supports a circuit block 116-1 that implements 32 nm transistor gate technology. In other words, circuit block 116-1 implements transistors with gates of 32 nm and lower. In this example, integrated voltage regulator 112-N supports a circuit block 116-N that implements 180 nm transistor gate technology. Circuit block 116-N implements transistors with gates of 180 nm.

Example System on a Chip

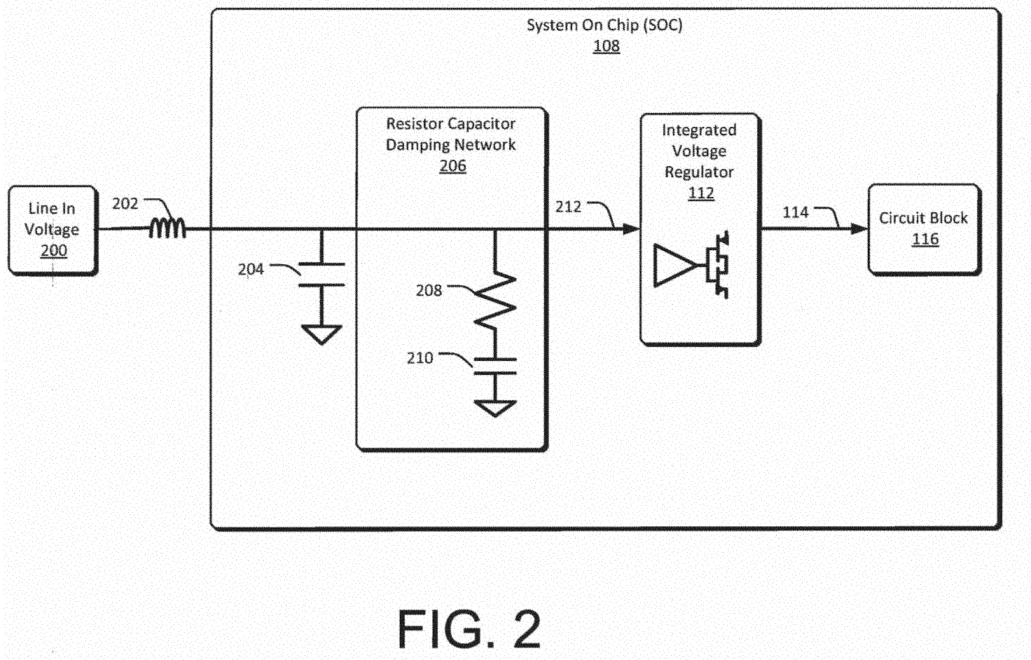

FIG. 2 is an example system on a chip (SOC) 108 implementing a resistor capacitor damping network to damp voltage ringing. A line in voltage 200 provides an input voltage to SOC 108. Line in voltage 200 may be external voltage regulator 106 discussed above, or another input voltage.

An inherent parasitic inductance 200 is created outside of SOC 108; however, as discussed, some parasitic inductance may be present within SOC 108. Furthermore, an inherent capacitance may be present due to the input voltage. The parasitic inductance with the inherent capacitance may form a resonant circuit excited by the pulses of current drawn by the switching integrated voltage regulator 112, which causes ringing at the natural frequency of the resonant circuit. In certain implementations, a decoupling capacitor 204 is provided to lower voltage. It is the intent to minimize the size of the decoupling capacitor 204 to minimize increases in die size.

The SOC 108 includes a resistor capacitor damping network 206 to reduce ringing that may lead to electrical overstress of the components/devices of circuit block 116. The resistor capacitor damping network 206 includes a resistor 208 and capacitor 210. The values of resistor 208 and capacitor 210, are related to the parasitic inductance 202, and not necessarily to the line voltage 200. Therefore, ringing at the line 212 is damped before received by switching integrated voltage regulator 112.

Example Reduction of Ringing

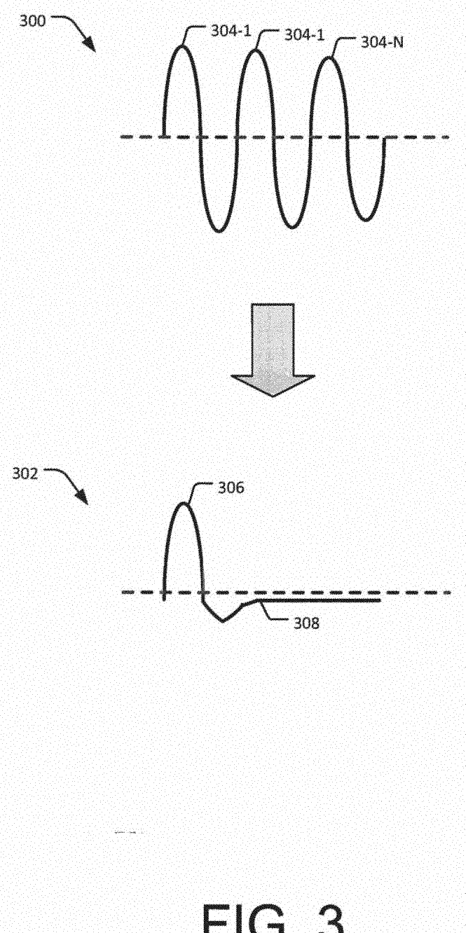

FIG. 3 is a diagram illustrating reduction of ringing in an example system on a chip (SOC) implementing a resistor capacitor damping network. Ringing due to patristic inductance and inherent capacitance of an input voltage is represented by graphs 300 and 302. Graph 30) in particular represents ringing along line 212 without a resistor capacitor damping network, and graph 302 represents ringing along line 212 with a resistor capacitor damping network.

Graph 300 shows voltage peaks 304 that extend and take a considerable time to go away. Such a ringing can cause voltage electrical overstress due to the non-dissipated energy represented by the voltage peaks 302. Continued non-dissipated energy at the input of integrated voltage regulator 112 can affect reliability of the integrated voltage regulator 112.

By providing a resistor capacitor damping network, graph 302 represents an initial peak 306, following a by a damping which leads to a lower energy spike 308. The lower energy spike 308 leads to greater reliability of the integrated voltage regulator 112.

Example Process

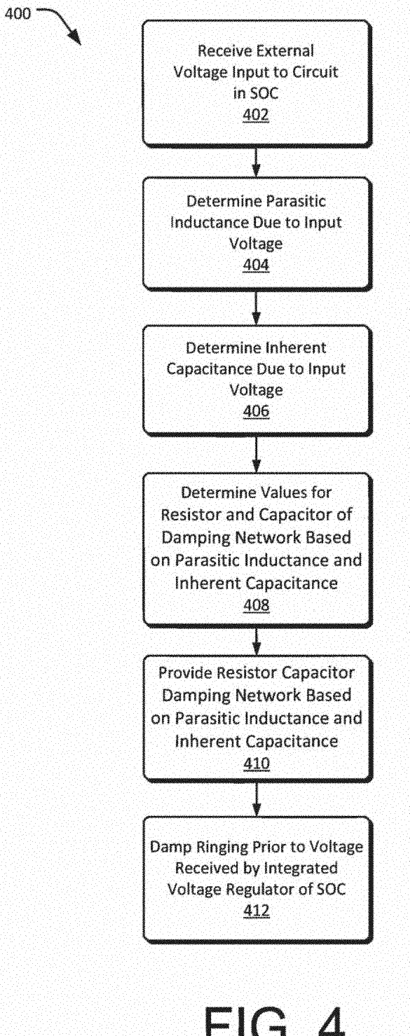

FIG. 4 shows an example process 400 for reducing ringing to improve integrated voltage regulators. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 402, an SOC receives an external voltage input. The voltage input may be from a power supply or battery of a device in which the SOC resides. The voltage may go through an external voltage regulator before input to the SOC.

At block 404, determining a parasitic inductance attributable to the voltage input is performed. The parasitic inductance resides along an input line to the SOC of the voltage input.

At block 406, determining inherent capacitance attributable to the voltage input is performed. The inherent capacitance and parasitic inductance causes potential ringing of the voltage input, and particularly to an internal voltage regulator of the SOC.

At block 408, determining values of a resistor and capacitor for a damping network is performed. The values of the resistor and capacitor are related to the parasitic inductance attributable to the input voltage.

At block 410, the resistor capacitor damping network is provided to the circuit/network of the SOC that is receiving the input voltage. The resistor capacitor damping network is particularly provided before an integrated voltage regulator.

At block 412, damping of ringing of energy/voltage fluctuations is performed. The damping may be performed before the integrated voltage regulator, where the integrated voltage regulator provides a voltage to a circuit on the SOC. The circuit includes various devices/components, such as transistors. The transistors of the integrated voltage regular and the circuit may be based on several technologies, including 32 nm technology.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. An integrated circuit (IC) system on a chip (SOC) comprising:
integrated voltage regulator that receives an input voltage;
a circuit block that receives voltage from the integrated voltage regulator; and
a resistor capacitor damping network that reduces ringing cases by the input voltage.

2. The IC SOC of claim 1 wherein the received input voltage is from an external source to the IC SOC.

3. The IC SOC of claim 1 wherein the integrated voltage regulator is a switching integrated voltage regulator.

4. The IC SOC of claim 1 wherein the integrated voltage regulator implements 32 nm transistor gates.

5. The IC SOC of claim 1 wherein components and devices of the circuit block implements 32 nm transistor gates.

6. The IC SOC of claim 1 wherein integrated voltage regulator implement, and components and devices of the circuit block implements 180 nm transistor gates.

7. The IC SOC of claim 1 wherein values of a resistor and capacitor of the resistor capacitor damping network are determined by a parasitic inductance of the input voltage.

8. The IC SOC of claim 7 wherein the parasitic inductance is external to the IC SOC.

9. The IC SOC of claim 1, further comprising a decoupling capacitor to lower voltage.

10. The IC SOC of claim 1, wherein the IC SOC is part of a device.

11. A method for reducing ringing in integrated circuit (IC) system on a chip (SOC) comprising:
means for receiving an input voltage to the IC SOC;
means for integrating the input voltage;
means for damping the ringing prior to integrating the input voltage; and means for providing the integrated input voltage to a circuit block.

12. The method of claim 11 wherein the means for input voltage is received from a power supply external to the IC SOC.

13. The method of claim 11 wherein the means for integrating the input voltage includes switching voltage.

14. The method of claim 11 wherein the means for damping the ringing is based on a parasitic inductance of the input voltage.

15. The method of claim 11 wherein the means for damping the ringing reduces the ringing after an initial voltage spike.

16. The method of claim 11 wherein the means for providing is based on transistor gate technology of the circuit block.

17. A method for reducing ringing in integrated circuit (IC) system on a chip (SOC) comprising:
receiving an input voltage at the IC SOC;
determining parasitic inductance caused by the input voltage; and
providing a resistor capacitor damping network based on the parasitic inductance to reduce the ringing prior to voltage being provided to a circuit on the IC SOC.

18. The method of claim 17 wherein the receiving is from an external power supply or battery.

19. The method of claim 17 wherein the providing a resistor capacitor damping network is before a switching integrated circuit that provides the voltage to the circuit.

20. The method of claim 17 further comprising decoupling capacitance due to the input voltage.
